(19) United States
(12) Patent Application Publication
(10) Pub. No.: US 2013/0327702 A1
(43) Pub. Date: Dec. 12, 2013

(54) STRUCTURE OF AN ELECTROCHEMICAL SEPARATION MEMBRANE AND MANUFACTURING METHOD FOR FABRICATING THE SAME

(71) Applicant: ENERAGE INC., Yilan County (TW)

(72) Inventors: Mark Y. Wu, Yilan County (TW); Cheng-Yu Hsieh, Yilan County (TW); Yuan-Hsin Chang, Yilan County (TW); Jing-Ru Chen, Yilan County (TW); Shu-Ling Hsieh, Yilan County (TW)

(73) Assignee: ENERAGE INC., Yilan County (TW)

(21) Appl. No.: 13/671,386

(22) Filed: Nov. 7, 2012

(30) Foreign Application Priority Data
Jun. 11, 2012 (TW) 101120929

(51) Int. Cl. B01D 69/10; B01D 71/34; B01D 71/42; B01D 71/02; B01D 71/56; B01D 71/64; B01D 71/48; B01D 67/00; B01D 71/54

(52) U.S. Cl. CPC B01D 69/10; B01D 67/0002; B01D 71/34; B01D 71/42; B01D 71/54; B01D 71/56; B01D 71/64; B01D 71/48; B01D 71/024
USPC 210/499; 427/385.5

(57) ABSTRACT

A structure of an electrochemical separation membrane and a manufacturing method for fabricating the same are disclosed. The structure of an electrochemical separation membrane includes a base-phased polymer part in form of a continuous phase structure, a fabric-supported part distributed in the base-phased polymer part in striped shape to provide mechanic strength thereto, and inorganic particles distributed uniformly in the base-phased polymer part with 0.1 wt %˜50 wt %, wherein the fabric-supported part is a porous structure with a plurality of micro holes such that the base-phased polymer part filled into the micro holes to obtain better adhesive strength, inorganic particles distributed uniformly in the base-phased polymer part to reduce the shrinking of separation membrane and hence improving the thermal stability under high temperature. A lithium ion battery applying the electrochemical separation membrane of the present invention can reduce resistance, increase charge/discharge capacitance and prolong lifespan.

### CROSS-REFERENCE TO RELATED APPLICATION

This application claims the priority of Taiwanese patent application No. 101120929, filed on Jun. 11, 2012, which is incorporated herewith by reference

### BACKGROUND OF THE INVENTION

1. Field of the Invention

The present invention relates to a structure of an electrochemical separation membrane and a manufacturing method for fabricating the sane, more particularly to an electrochemical separation which is used in a lithium ion battery for improving the shrinkage and enhances the safety of the batteries under high temperature.

2. The Prior Arts

The traditional secondary batteries, such as nickel-cadmium batteries and nickel-hydride batteries, have been replaced by secondary lithium ion batteries since the secondary lithium ion batteries were presented to the public due to the advantages of high energy density and long circle of lifespan. Since Sony Company commoditized the secondary lithium ion batteries in 1991, the share-of-market of the secondary lithium ion battery is increased continuously, and the global output value of the secondary lithium ion battery surpasses the total sum of the nickel-cadmium batteries and the nickel-hydride batteries in a decade. Based on technology of the battery design and improvement materials in existence and the development of new materials, the application fields of the secondary lithium ion batteries are broadened. Hence, the secondary lithium ion batteries become the first choice in 3C products recently due to its advantages of the lighter, shorter and thinner designs.

In the markets of consumer electronics and electric vehicles, the most important evaluating item is safety. Therefore, raising the safety of the safety-related materials such as the separation membrane is the key work in battery design. The function of the separation membrane is to separate the electrons and to make the ions pass through freely, and to avoid occurrence of the short circuit between the anode and the cathode. In addition, the separation membrane of the secondary lithium ion battery is required to shutdown the micro holes which function as ions-passages when the temperature of battery raises abnormally to avoid the thermal escape, burning and further explosion due to the continuously rising of the temperature. Therefore, the strength, thickness, distribution of micro holes and thermal actuating of the separation membrane, as the quality indexes, determine the factors of the capacitance of battery, circle lifetime of battery and safety, and also influence the marketing development. Moreover, the price of the separation membrane is only 20% of the cost of the secondary lithium ion battery, such that the development of the separation membrane plays an important factor in the field.

Recently, most of the secondary lithium ion batteries use porous polyolefin polymers as the separation membrane, wherein the polyolefin polymers include polypropylene (PP), polyethylene (PE) and PP/PE/PP layer-laminated. The polyolefin polymers have the advantages of low-cost, good mechanical strength and high chemical stability.

Manufacturing methods for fabricating the separation membrane are divided into a dry type method and a wet type method. The processes of dry type method are disclosed in U.S. Pat. Nos. 5,952,120, 6,207,053 and 6,368,742. Those methods use polyolefin polymers, i.e. PE, PP and PP/PE/PP layer-laminated, as the main materials for manufacturing the separation membrane. Firstly, extruding the melting materials into a membrane and then stretching out in single direction or bi-directionally. In the stretching process, the lamella structure of hard elastic materials, which is arranged in parallel and perpendicular to the extruding direction are stretched to form micro holes. Finally, those micro holes are fixed by a thermal boarding process. The cost of the dry type method is low, but the ultimate price of the separation membrane is still high because the conditions of processes are strict to meet the specification of the secondary lithium ion battery. The shape of micro holes manufactured by the dry type method is straight, and short circuit may occur in the cathode end of the secondary lithium ion battery because the separation membrane is pierced by the lithium crystal. In order to solve the safety problem, manufacturing a thermal resistance layer or adding inorganic particles are generally used.

For the lithium ion battery system, since the polarity of the polyolefin polymers is very low, and the electrolyte of the lithium ion battery is an organic solution with high dielectric coefficient and high polarity in which lithium salts are dissolved, such that the affinity between the polyolefin polymers and electrolyte is not good, so that it causes the bad wetting effect of electrolytes to the separation membrane, and the ion electric conductivity of whole lithium ion battery is lower than the ion electric conductivity of the electrolytes. In order to improve the affinity between the polyolefin polymers and electrolyte and raise the wetting effect, some researches modify the surface properties of the polyolefin polymers, for example, U.S. Pat. No. 6,322,923 disclosed that a gelatinous polymer is covered on the polyolefin porous membrane to enhance the wetting effect. On the other hand, some methods change the material of the separation membrane with materials having high-affinity to the electrolyte, and it further raises the affinity to the anode and cathode boards.

As described above, the micro holes of the separation membrane should be shutdown to stop the ion conduction and further cut off the current when the batteries is overheated due to the exothermal reaction or is subjected thermal breaking due to external high intensive heat. When the material reaches the melting point, i.e., the melting point of polyethylene is 120° C., the state of the separation membrane changes from solid state to liquid state, and the mechanism of shutdown starts. However, in order to prevent the anode from contacting the cathode directly in the melting state, the integrity of the separation membrane should be maintained before melting. As the internal temperature of the battery increases continuously, the separation membrane will meltdown finally, and causes short circuit due to contact of anode and cathode, and the battery may explode. The temperature difference between shutdown and meltdown is so-called safe threshold, and the temperature difference of traditional or general polyolefin separation membrane is relatively small, for example, 30° C. to 50° C., and based on molecular mass of the materials. Recently, the manufacturers of the separation membrane realize the disadvantages of traditional separation membrane (the main material is PE), and are searching to improve the safety in some ways. Hence, inorganic composite separation membrane will play a key role within the technologies in manufacturing separation membrane of high power capacitance batteries in the near future.

Nowadays, a single-layered PE separation membrane is used in most of the inorganic composite separation membranes as a base material composition of the inorganic composite separation membrane. The purposes of using the single-layered PE separation membrane are to maintain the thickness of the inorganic composite separation membrane, and also to maintain the mechanical strength and high thermal resistance. The inorganic composite separation membrane mainly includes polyamide, nano-meter oxide(Al₂O₃ and SiO₂), a base material and a ceramic composite layer, wherein the base material of the inorganic composite separation membrane is a single-layered porous PE thin film (14˜16 μm), the ceramic composite layer (4 μm) is used to enhance the mechanical strength and the uniformity of thermal conductivity of the single-layered porous PE thin film, and the total thickness of the inorganic composite separation membrane is 18˜20 μm. In addition, the porosity of ceramic composite layer (60˜65%) is higher than the porosity of the single-layered porous PE thin film (30˜35%), such that the ceramic composite layer has no influence regarding the wetting effect of the separation membrane and the permeation of the lithium ions.

U.S. Pat. No. 7,959,011 disclosed a separation membrane made of a PET non-woven fabric mixed with Al₂O₃, ZrO₄ and SiO₂. Since an inorganic layer is formed between the metal oxide and PET after continuous dipping, drying and sintering, such that the separation membrane has higher thermal stability and deform resistance under heating, and does not shrink and melt under 200° C. Therefore, the safety of the power batteries is improved. However, the cohesive strength between the composite layer and base material membrane is not sufficiently enough, and the stability of separation membrane is neither enough.

Chinese patent publication No. 101481855A disclosed a manufacturing method of SiO₂/polyvinylidene nano-composite fabric membrane. This method applies sol-gel principle to change the properties of the nano SiO₂ particles, co-mixes the nano SiO₂ particle and the polyvinylidene, and finally manufactures the nano-composite fabric membrane with the electrospinning technology. Chinese patent publication No. 101826606A disclosed a polytetrafluoroethene lithium ion battery separation membrane and manufacturing method thereof. In this method, a polytetrafluoroethene porous membrane is used as a base material, then a polymer is formed on one or two surfaces of the base material by dipping, coating or sprays coating, and finally a composite membrane is obtained after drying and thermal-pressing shaping. The lifespan and safety (the shutdown temperature is about 100˜150° C.) of the battery separation membrane is improved based on its chemical stability, thermal stability and antioxidative activity.

US patent publication No. 2010/0,316,903 A1 also describes a method for manufacturing composite separation membrane. In this method, firstly coating a slurry consist of adhesive and ceramic particles on a surface of a porous base material, wherein the adhesive is a cross-linking polymer, such that the adhesive and the porous base material cross-links after slurry coating, and the adhesion strength between the adhesive and the base material is enhanced. US patent publication No. 2012/0,015,254 A1 disclosed enhancing the adhesion strength by another method, the method coats slurry comprising adhesive and ceramic particles with dielectric coefficient higher than 5 on a porous base material firstly, and then coating a polymer solution on the outside by the electrochemical method to form a second coating layer for covering the base material and enhancing the stability of the separation membrane. However, the second cross-linking or the second coating makes the processes more complicated.

Summarizing the description above, in order to prevent the separation membrane of the high power lithium ion battery from deforming or twisting under high temperature and thus influencing the safety of lithium ion battery, the mechanical strength and thermal stability should be improved to enhance the safety of the lithium ion battery; and most of the prior arts coat slurry with ceramic particles on the two sides of the base membrane to form protection layers, however, the thickness and the accuracy of the protection layers are difficult to control and the adhesive strength is not sufficiently enough, and it could influence the performance of the separation membrane.

### SUMMARY OF THE INVENTION

A main objective of the present invention is to provide a structure of electrochemical separation membrane including a base-phased polymer part, a fabric-supported part and inorganic particles, wherein the fabric-supported part is striped-shape and distributed in the base-phased polymer part to provide the mechanic strength for supporting the base-phased polymer part, and the inorganic particles are uniformly distributed in the base-phased polymer part with 0.1 wt %˜50 wt %, and the base-phased polymer part is formed around the fabric-supported part in a continuous phase structure and has porous structure. The total thickness of the electrochemical separation membrane 1 ranges between 10˜60 μm.

The fabric-supported part is selected from the group consisting of at least one of polyolefine fibers, and has a porous structure with micro holes, such that the base-phased polymer part can fill into those micro holes and combine with the fabric-supported part tightly. The inorganic particles are selected from the group consisting of at least one of metal oxides, metal carbides, metal nitrides, metal titanate, and metal phosphate, and the particle size ranges between 0.01˜30 μm. The inorganic particles have high burning temperature, and high decomposition temperature to prevent the temperature from over-rising, and provide support strength for the base-phased polymer part to prevent the electrochemical separation membrane from over shrinking.

The other objective of the present invention is to provide a manufacturing method for fabricating an electrochemical separation membrane including polymer slurry preparing step, a coating step, and a drying step. The polymer slurry preparing step is to prepare a polymer base-phased material solution comprising a polymer base-phased material, solvent and inorganic particles, wherein the polymer base-phased material is dissolved in the solvent and the inorganic parties are distributed in the polymer base-phased material solution with 0.1 wt %˜50 wt %. In addition, the polymer base-phased material solution further includes an adhesive.

The coating step is to form the polymer base-phased material solution around a porous fabric support part by dipping or coating such that the polymer base-phased material can fill into the micro holes of the porous fabric support part and an electrochemical separation membrane is thus formed. The drying step is to dry the polymer base-phased material solution by standing still, air drying or heating such that the electrochemical separation membrane with the base-phased polymer part, the fabric-supported part and the inorganic particles is thus formed.

The technical features in the structure and a manufacturing method for fabricating the electrochemical separation membrane of present invention are that the polymer base material solution fill into the micro holes of the fabric-supported part to provide the mechanic strength in the structure of the electrochemical separation membrane of the present invention such that the adhesive strength is improved. Moreover, the inorganic particles reduce the shrinking of separation membrane and improve the thermal stability under the high temperature. Further, the lithium ion battery applying the electrochemical separation membrane of present invention has reduced total resistance, increased charge/discharge capacitance and longer lifespan.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a top view conceptual diagram of the microstructure of the electrochemical separation membrane of the present invention.

FIG. 2 is a partial enlarged drawing of base-phased polymer part in FIG. 1.

FIG. 3 is a flow chart of the manufacturing method for fabricating an electrochemical separation membrane of the present invention.

FIGS. 4A to 4C are diagrams showing the charge/discharge testing and lifetime analysis of the lithium ion battery used the electrochemical separation membrane of Experiment Example 1 comparing with the lithium ion battery used commercial Celgard 2320 separation membrane.

FIG. 4D is a diagram showing the relationship of current density and capacitance of the battery used the electrochemical separation membrane of Experiment Example 1.

FIG. 5 is a diagram showing the results of charge/discharge properties of the battery used the electrochemical separation membrane of Experiment Example 2 by rates of 1 C and 3 C.

FIGS. 6A to 6B are diagrams showing the charge/discharge testing by rates of 0.2 C and 3 C and thermal performance at 55° C. of the lithium ion battery using the electrochemical separation membrane of Experiment Example 4 comparing with the lithium ion batteries used commercial Celgard 2320, 2400 separation membranes.

### DETAILED DESCRIPTION OF THE PREFERRED EMBODIMENTS

The accompanying drawings are provided for further understanding of the invention, and are incorporated in and constitute a part of this specification. The drawings illustrating the embodiments of the invention together with the description, serve to explain the principles of the present invention.

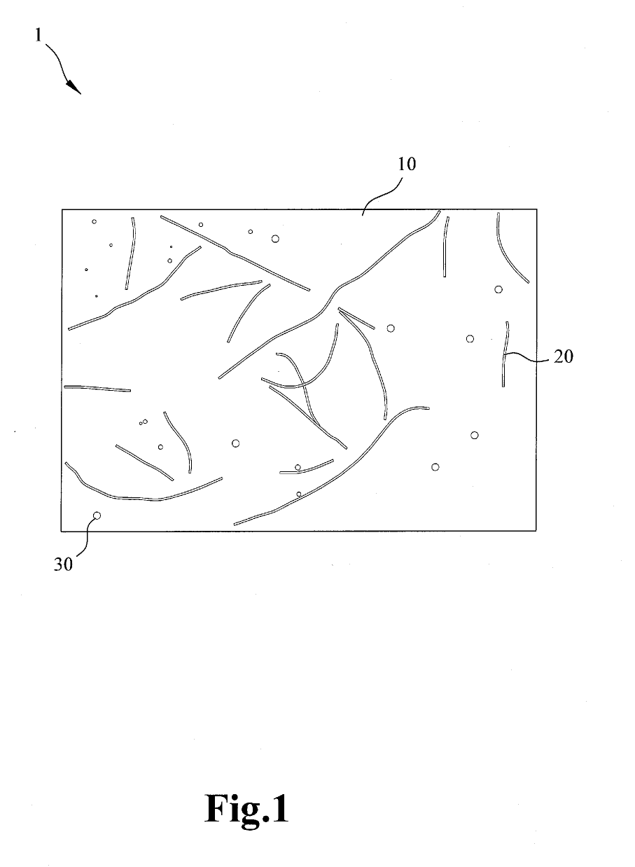

Please refer to FIG. 1, which is a top view conceptual diagram of the microstructure of the electrochemical separation membrane of the present invention. As shown in FIG. 1, the structure of the electrochemical separation membrane 1 of the present invention includes a base-phased polymer part 10, a fabric-supported part 20 and inorganic particles 30, wherein the fabric-supported part 20 is striped-shape and is distributed in the base-phased polymer part 10 to provide the mechanic strength for supporting the base-phased polymer part 10. The inorganic particles 30 are uniformly distributed in the base-phased polymer part 10 with 0.1 wt %˜50 wt %. The base-phased polymer part 10 is formed around the fabric-supported part 20 in continuous phase structure and is porous structure. The total thickness of the electrochemical separation membrane 1 ranges between 10˜60 μm.

The base-phased polymer part 10 is selected from the group consisting of at least one of polyvinylidene fluoride, polyethylene terephthalate, polyurethane, polyethylene oxide, polypropylene oxide, polyacrylonitrile, polyacrylamide, polymethyl acrylate, polymethyl methacrylate, polyvinylacetate, polyvinylpyrroidone, polytetraethylene glycol diacrylate and polyimide, and becomes gelatinous when the base-phased polymer part 10 contacts with the electrolyte.

The fabric-supported part 20 is selected from the group consisting of at least one of polyethylene fibers, polypropene fibers, polybutene fibers, polypentene fibers, and polyethylene terephthalate fibers, and the diameter of the fabric-supported part 20 ranges between 0.5˜30 μm. The fabric-supported part 20 is a porous structure and has micro holes with diameter ranging 0.1˜20 μm, such that the base-phased polymer part 10 can fill into those micro holes and combined with the fabric-supported part 20 tightly.

The inorganic particles 30 are selected from the group consisting of at least one of metal oxides, metal carbides, metal nitrides, metal titanate, and metal phosphate, and the particle size is in the range of 0.01˜30 μm, wherein Al₂O₃, SiO₂, TiO₂, CaCu₃Ti₄O₁₂, Li₄Ti₅O₁₂, CaCO₃, ZrO₄, CaO, LiFePO₄ are preferred. The inorganic particles 30 has high burning temperature, and high decomposition temperature to prevent the temperature from over rising, and provides support strength to the base-phased polymer part 10 to prevent the electrochemical separation membrane 1 from over shrinking.

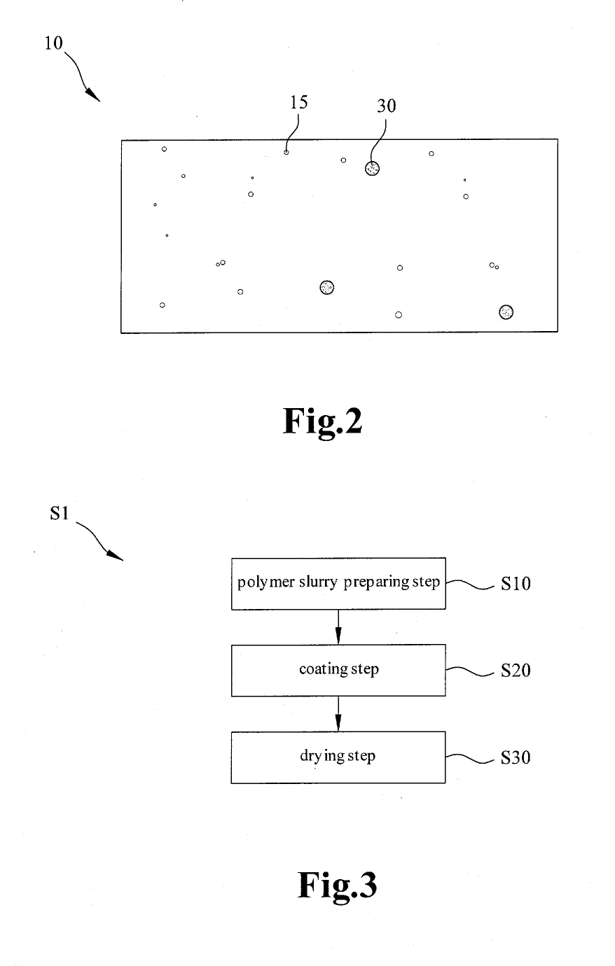

Please refer to FIG. 2, which is a partial enlarged drawing of base-phased polymer part in FIG. 1. As shown in FIG. 2, not only the inorganic particles 30 are comprised in the base-phased polymer part 10, but also a plurality of micro holes are distributed uniformly, wherein the diameter of those micro holes ranges between 0.1˜5 μm, and the porosity of the base-phased polymer part 10 ranges between 40˜75%.

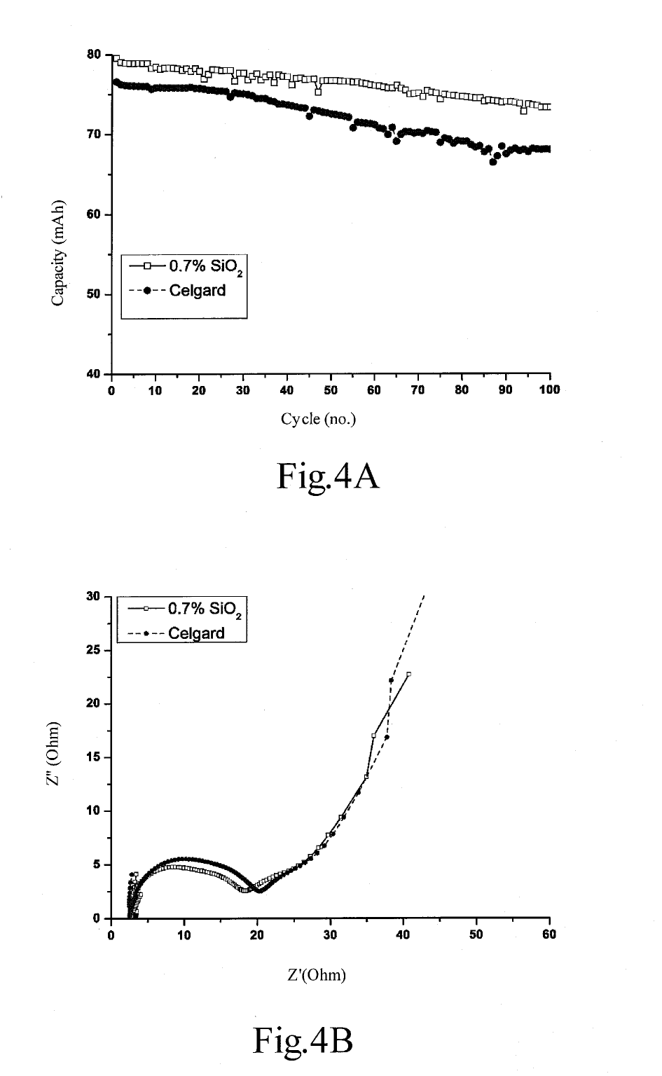

Please refer to FIG. 3, which is a flow chart of the manufacturing method for fabricating an electrochemical separation membrane of the present invention. As shown in FIG. 3, the manufacturing method S1 of an electrochemical separation membrane of the present invention includes a polymer slurry preparing step S10, a coating step S20, and a drying step S30. The polymer slurry preparing step S10 is to prepare a polymer base-phased material solution including a polymer base-phased material, solvent and inorganic particles, wherein the polymer base-phased material is dissolved in the solvent and the inorganic parties are distributed in the polymer base-phased material solution with 0.1 wt %˜50 wt %. In addition, the polymer base-phased material solution further includes an adhesive. The base-phased polymer part is selected from the group consisting of at least one of polyvinylidene fluoride, polyethylene terephthalate, polyurethane, polyethylene oxide, polypropylene oxide, polyacrylonitrile, polyacrylamide, polymethyl acrylate, polymethyl methacrylate, polyvinylacetate, polyvinylpyrroidone, polytetraethylene glycol diacrylate and polyimide. The solvent is selected from the group consisting of at least one of acetone, butanone, N-methylpyrrolidone, tetrahydrofuran, dimethylformamide, dimethylacetamide, and tetramethylurea.

The adhesive can be selected from the group consisting of at least one of cellulose acetate, cellulose acetate butyrate, cellulose acetate propionate, ethyl cellulose, cyanoethyl cellulose, cyanoehyl polyvinyl alcohol and carboxymethyl cellulose, and has a weight percentage 0.1˜20 wt % to the organic particles.

The coating step S20 to form the polymer base-phased material solution around a porous fabric support part by dipping or coating; such that the polymer base-phased material can fill into the micro holes of the porous fabric support part and an electrochemical separation membrane is formed.

The drying step S30 is to make the solvent vaporize from the polymer base-phased material solution by standing, air drying or heating; such that the polymer base-phased material is dried and the electrochemical separation membrane 1 with the base-phased polymer part 10, the fabric-supported part 20 and the inorganic particles 30 as shown in FIG. 1 is formed.

The following four experimental examples are conducted to describe the structure and manufacturing of the electrochemical separation membrane and those experimental examples are only used to describe the preferred embodiments, but not to limit.

### EXPERIMENTAL EXAMPLE 1

In Experimental Example 1, dissolving the polyvinylidene fluoride into acetone and adds SiO₂ particles (particle size are about 5 nm) of 0.7 wt %, and then stirrings 16 hours or more to form slurry as the polymer base-phased material solution. Then, coating the polymer base-phased material solution on polypropene fibers by dip coating.

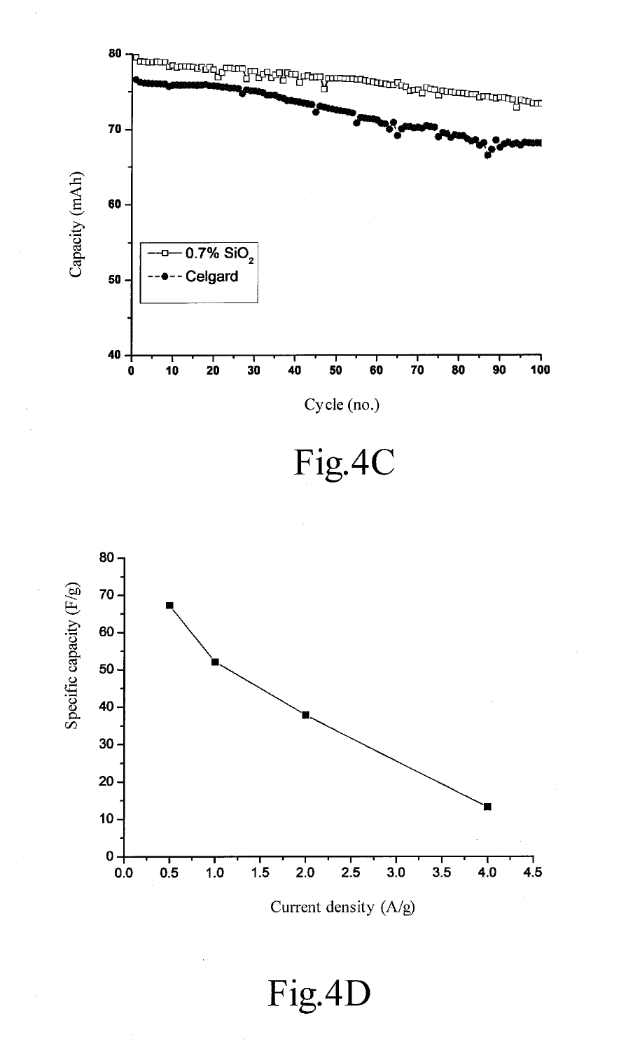

Combine the dried electrochemical separation membrane made from Experimental Example 1 with LiFePO₄ to form the anode material, lithium foil to form the cathode material, and LiPF₆ to form the electrolyte as a button cell by the traditional combining technology, and then compares the fast charge/discharge property and the lifespan with the button cell with commercial Celgard 2320 separation membrane. The result is shown as FIGS. 4A to 4C, it shows that the performance of the electrochemical separation membrane made of Experimental Example 1, is similar to the commercial separation membrane under different discharge rate, and the impedance is also similar to the commercial separation membrane, in addition, the lifespan of the device is further increased. Therefore, the electrochemical separation membrane, made from Experimental Example 1, is used as the separation membrane of an electrochemical device.

Combine the dried electrochemical separation membrane made of Experimental Example 1, active carbon to form the anode and cathode material, and LiPF₆ to form the electrolyte as a button super capacitance by the traditional combining technology, and then test the charge/discharge properties under different current density. The relationship of capacitance and electrochemical current density of the button super capacitance with the electrochemical separation membrane, made from Experimental Example 1, is shown as FIG. 4D; the results show that the electrochemical separation membrane, made from Experimental Example 1, is applied in the button super capacitance.

In addition, test the thermal shrink property of the electrochemical separation membrane, made from Experimental Example 1, under high temperature and compare with the commercial Celgard 2320 separation membrane. The test method is that fix two ends of the separation membrane on a glass carrier, then heat 2 hours in the heater with a constant temperature 130° C. After this test, the commercial Celgard 2320 separation membrane shrinks over 20%, but the electrochemical separation membrane, made from Experimental Example 1, only shrinks 1% or less. Therefore, we can understand that filling polymer of the continuous phase structure and adding the inorganic reduce the thermal shrinking at high temperature, and improve the safety at high temperature.

### EXPERIMENTAL EXAMPLE 2

Experimental Example 2 uses an explanted and high density fabric material as the fabric-supported part; such that the gelatinous polymer base material solution can fill into micro holes of the porous fabric material to form the electrochemical separation membrane. The manufacturing method of Experimental Example 2 is similar to the Experimental Example 1, and Experimental Example 2 uses the polyvinylidene/acetone solution and adds SiO₂ particles of 1.5 wt %, and then stirs 8 hours or more to form slurry as the polymer base-phased material solution. Then, coat the polymer base-phased material solution on the explanted polypropene fibers by dip coating.

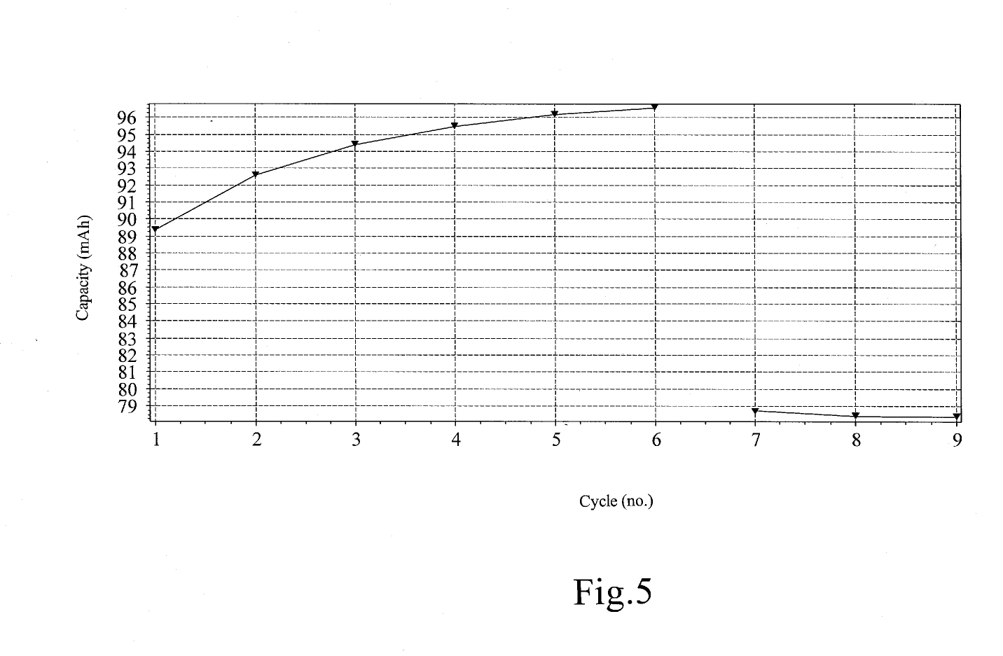

Combine the dried electrochemical separation membrane, made from Experimental Example 2, with LiFePO₄ to form the anode material, lithium foil to form the cathode material, and LiPF₆ to form the electrolyte as a button cell by the traditional combining technology, and then test the charge/discharge properties by rates of 1 C and 3 C, the results are shown in FIG. 5.

### EXPERIMENTAL EXAMPLE 3

Experimental Example 3 uses the polyvinylidene/acetone solution described above and adds CaCu₃Ti₄O₁₂ (CCTO) particles of 1.5 wt %, and then stirs uniformly to form slurry as the polymer base-phased material solution, wherein the crystal structure CaCu₃Ti₄O₁₂ is the pervoskite cubic structure, which has keep a huge dielectric coefficient in a temperature range. Meanwhile, the ethyl cellulose is added into the slurry as adhesive, then stirs for 4 hours or more, and coat the polymer base-phased material solution on the polypropene fibers by dip coating. After fully drying in the room temperature, the electrochemical separation membrane with thickness 30-40 μm is thus obtained, in which a porous fabric material is used a support part, and a continuous phase structure of polyvinylidene/CaCu₃Ti₄O₁₂ fill into the micro holes of the porous fabric material.

### EXPERIMENTAL EXAMPLE 4

Experimental Example 4 uses a high density polyethylene membrane as a support part, and coat the polyvinylidene fluoride/acetone solution with 0.7 wt % SiO₂ particles on the high density polyethylene membrane by dip coating to form a electrochemical separation membrane.

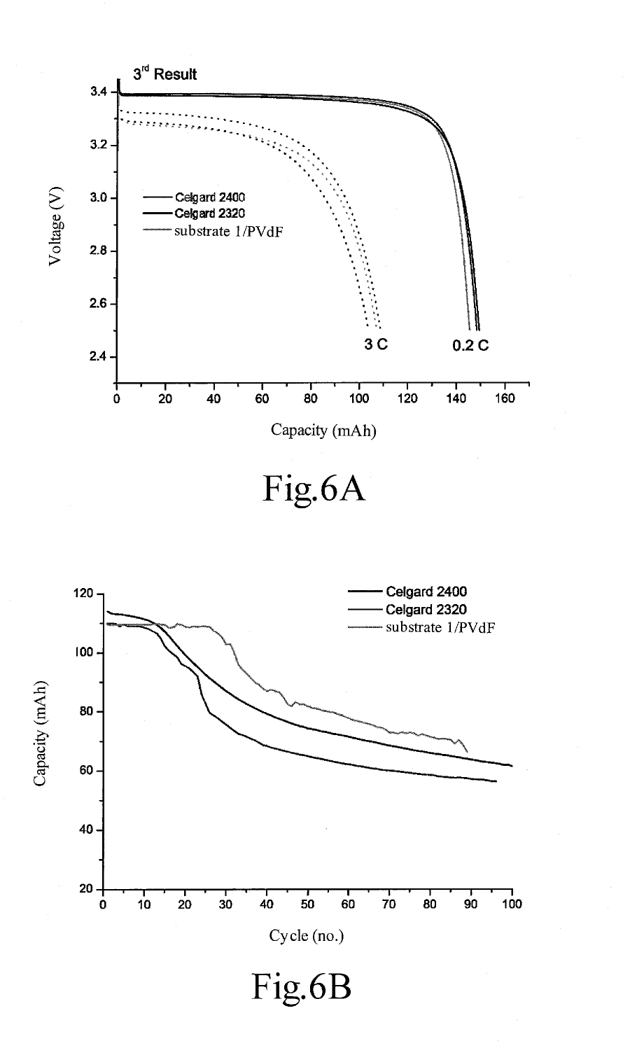

Combine the dried electrochemical separation membrane, made from Experimental Example 4, with LiFePO₄ to form the anode material, lithium foil to form the cathode material, and LiPF₆ to form the electrolyte as a button cell by the traditional combining technology, and then test charge/discharge properties by rates of 0.2 C and 3 C and high temperature performance, and compare with commercial Celgard 2320 and 2400 separation membranes, the results are shown as FIGS. 6A and 6B. The results show that the electrochemical separation membrane, made from Experimental Example 4, has better stability and performance under high temperature.

The technical features in the structure and a manufacturing method for fabricating an electrochemical separation membrane of present invention are that the polymer base material solution are filled into the micro holes of the fabric-supported part providing the mechanic strength in the structure of the electrochemical separation membrane of the present invention, such that the adhesive strength is improved. Moreover, the inorganic particles reduce the shrinking of separation membrane and improve the thermal stability under the high temperature. Further, the lithium ion battery applying the electrochemical separation membrane of present invention possesses reduced total resistance, increased charge/discharge capacitance and longer lifespan.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A structure of an electrochemical separation membrane, comprising:
a base-phased polymer part in form of a continuous phase structure;
a fabric-supported part distributed in the base-phased polymer part in striped shape in order to provide mechanic strength thereto; and
inorganic particles distributed uniformly in the base-phased polymer part with 0.1 wt %˜50 wt %,
wherein the fabric-supported part is a porous structure with a plurality of micro holes such that the base-phased polymer part is filled into the micro holes.

2. The structure of the electrochemical separation membrane according to claim 1, wherein the base-phased polymer part is selected from the group consisting of at least one of polyvinylidene fluoride, polyethylene terephthalate, polyurethane, polyethylene oxide, polypropylene oxide, polyacrylonitrile, polyacrylamide, polymethyl acrylate, polymethyl methacrylate, polyvinylacetate, polyvinylpyrroidone, polytetraethylene glycol diacrylate and polyimide.

3. The structure of the electrochemical separation membrane according to claim 1, wherein the base-phased polymer part becomes gelatinous when contacts an electrolyte.

4. The structure of the electrochemical separation membrane according to claim 1, wherein the electrochemical separation membrane has a total thickness ranging 10˜60 μm.

5. The structure of the electrochemical separation membrane according to claim 1, wherein the fabric-supported part is selected from the group consisting of at least one of polyethylene fibers, polypropene fibers, polybutene fibers, polypentene fibers, and polyethylene terephthalate fibers, a diameter of the fabric-supported part ranges between 0.5˜30 μm, and a size of the micro holes ranges between 0.1˜20 μm.

6. The structure of the electrochemical separation membrane according to claim 1, wherein the inorganic particles are selected from the group consisting of at least one of metal oxides, metal carbides, metal nitrides, metal titanate, and metal phosphate, and the particle size of the inorganic particles ranges between 0.01˜30 μm.

7. The structure of the electrochemical separation membrane according to claim 1, wherein the base-phased polymer part further includes a plurality of micro holes with size of 0.1˜5 μm, and a porosity of the base-phased polymer part is 40˜75%.

8. A manufacturing method for fabricating an electrochemical separation membrane, comprising:
a polymer slurry preparing step: preparing a polymer base-phased material solution including a polymer base-phased material dissolved in solvent and inorganic particles with 0.1 wt %˜50 wt % distributed in the polymer base-phased material solution;
a coating step: forming the polymer base-phased material solution around a porous fabric support part by dipping or coating, wherein the polymer base-phased material is filled into the micro holes of the porous fabric support part and the electrochemical separation membrane is thus formed; and
a drying step: drying the electrochemical separation membrane by keeping the same standing still, air drying or heating.

9. The manufacturing method for fabricating the electrochemical separation membrane according to claim 8, wherein the polymer base-phased material is selected from the group consisting of at least one of polyvinylidene fluoride, polyethylene terephthalate, polyurethane, polyethylene oxide, polypropylene oxide, polyacrylonitrile, polyacrylamide, polymethyl acrylate, polymethyl methacrylate, polyvinylacetate, polyvinylpyrroidone, polytetraethylene glycol diacrylate and polyimide.

10. The manufacturing method for fabricating the electrochemical separation membrane according to claim 8, wherein the porous fabric support part is selected from the group consisting of at least one of polyethylene fibers, polypropene fibers, polybutene fibers, polypentene fibers, and polyethylene terephthalate fibers, a diameter of the fabric-supported part ranges between 0.5˜30 μm, and a size of the micro holes ranges between 0.1˜20 μm.

11. The manufacturing method for fabricating the electrochemical separation membrane according to claim 8, wherein the inorganic particles are selected from the group consisting of at least one of metal oxides, metal carbides, metal nitrides, metal titanate, and metal phosphate, and a particle size of the inorganic particles ranges between 0.01˜30 μm.

12. The manufacturing method for fabricating the electrochemical separation membrane according to claim 8, wherein the solvent is selected from the group consisting of at least one of acetone, butanone, N-methylpyrrolidone, tetrahydrofuran, dimethylformamide, dimethylacetamide, and tetramethylurea.

13. The manufacturing method for fabricating the electrochemical separation membrane according to claim 8, wherein the polymer base-phased material solution further includes an adhesive which is selected from the group consisting of at least one cellulose acetate, cellulose acetate butyrate, cellulose acetate propionate, ethyl cellulose, cyanoethyl cellulose, cyanoehyl polyvinyl alcohol and carboxymethyl cellulose, and the adhesive has a weight percentage 0.1˜20 wt % of the organic particles.
